(19) United States
(12) Patent Application Publication
(10) Pub. No.: US 2013/0215395 A1
(43) Pub. Date: Aug. 22, 2013

(54) WIDE-ANGLE IMAGING LENS AND LOW-PROFILE PROJECTION LIGHT ENGINE USING THE SAME

(71) Applicant: Lin Li, Boise, ID (US)

(72) Inventor: Lin Li, Boise, ID (US)

(21) Appl. No.: 13/400,964

(22) Filed: Feb. 21, 2012

(51) Int. Cl. G03B 21/14; G02B 13/18; G02B 9/62

(52) U.S. Cl. 353/34; 359/759; 359/713

(57) ABSTRACT

Wide-angle imaging lens arrangements and methods are described for use with an image projector system including a display. A plurality of no more than six lenses can be arranged to receive an object image that emits from the display to propagate through the plurality of lenses to produce a high-quality projected image on a screen. The image projector system has a low f-number, low height profile and high resolution.

### FIELD OF THE INVENTION

Embodiments of the present invention are generally related to the field of projector systems and, more particularly, to the field of wide-angle imaging lens arrangements for use in low-profile projector systems.

### BACKGROUND

Expanding use of computers, handheld devices, tablets and other computation electronic devices is rapidly fueling increasing production, viewing and sharing of videos as well as stationary images, especially including digitized images that can be displayed, stored and transferred based on digital electronic signals.

While conventional displays, such as LCD panels, are commonly utilized as visual monitors for desktop and/or laptop computers, projector systems are sometimes employed, typically as external peripheral devices, to serve as an auxiliary display that can be advantageous at least in certain applications. In many cases, a given projector system may be configured, as an external peripheral device, to provide at least a reasonably portable means for projecting a video and/or stationary image that is substantially larger than the projector system. For example, high performance projector systems commonly employed in the context of business meetings, sales pitches and presentations, may be of sufficiently small overall size for at least reasonably convenient transport by way of a briefcase, and may be capable of displaying high quality and high brightness images on a projection screen. These projectors may be configured to produce the projected image in response to an electronic signal from computers and many other electronic devices.

There are numerous well known configurations of traditional projector systems, many of which include some type of projection lens arrangement that can be configured to receive an object image and to produce a projected image responsive thereto. As will be described hereinafter, the projection lens arrangement may be instrumental in defining, or at least influencing various performance specifications for a given projector system. In this regard, it is recognized that traditional approaches are limited with respect to the competing interests of miniaturization and efficiency in conjunction with providing high quality projected images.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic plan view of a low-profile projector system.

FIG. 2A is a diagrammatic plan view of an embodiment of an imaging lens arrangement for use with the low-profile projector system of FIG. 1.

FIG. 2B is a diagrammatic elevational view of a display.

FIG. 3 is a graphical representation of modulation transfer function (MTF) characteristics associated with the imaging lens arrangement of FIG. 2A.

FIG. 4 is a graphical representation of distortion characteristics associated with the imaging lens arrangement of FIG. 2A.

FIG. 5 illustrates a plot of relative intensity associated with the imaging lens arrangement of FIG. 2A.

FIG. 6 illustrates a plot of lateral color associated with the imaging lens arrangement of FIG. 2A.

FIG. 7A is a diagrammatic plan view of one embodiment with respect to a low profile projector system.

FIG. 7B is a diagrammatic plan view illustrating an embodiment of the imaging lens arrangement.

FIG. 7C is a diagrammatic plan view illustrating another embodiment of the imaging lens arrangement.

### DETAILED DESCRIPTION

The following description is presented to enable one of ordinary skill in the art to make and use embodiments of the invention and is provided in the context of a patent application and its requirements. Various modifications to the described embodiments will be readily apparent to those skilled in the art and the generic principles taught herein can be applied to other embodiments. Thus, embodiments of the present invention are not intended to be limited to the embodiments shown, but are to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

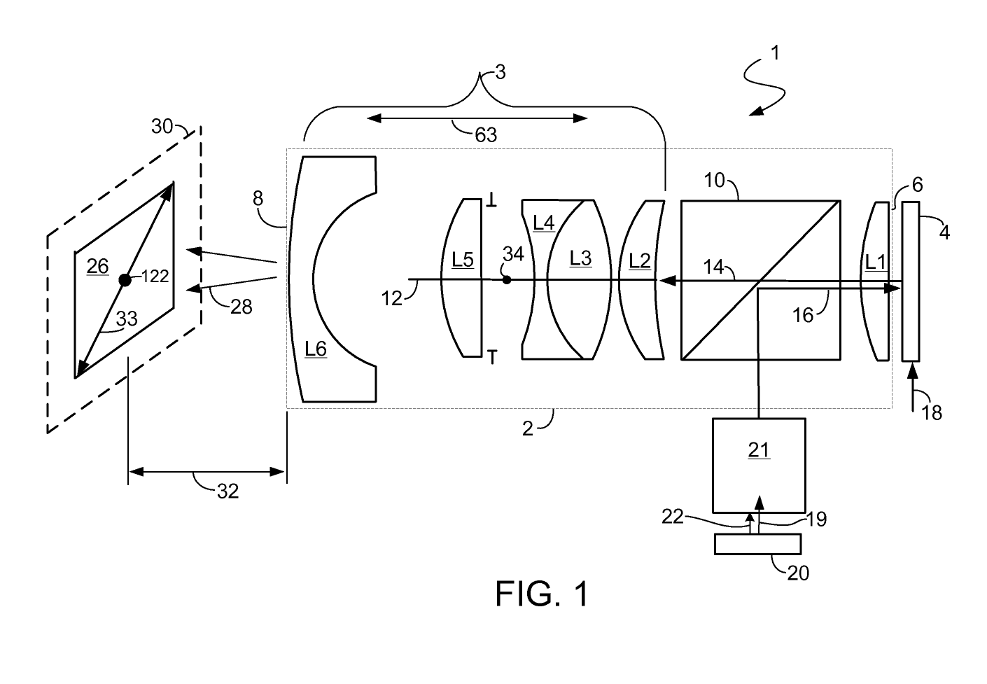

Attention is now directed to the figures wherein like reference numbers may refer to like components throughout the various views. FIG. 1 is a diagrammatic view, in elevation, of an embodiment of a projector system, produced according to the present disclosure, and generally indicated by reference number 1. Projector system 1 includes an imaging lens arrangement 2, indicated using a dashed box, including a first lens L1, and a subset of lenses 3, indicated using a bracket, that can include five lenses. As will be described in greater detail hereinafter, an embodiment of the projector system includes first lens L1 positioned in front of a display 4 and a plurality of lenses with first lens L1 serving as an entrance side 6, and an exit lens L6 serving as an exit side 8 of the imaging lens arrangement, with a beamsplitter 10 and lenses L2, L3, L4 and L5 disposed therebetween. The imaging lens arrangement defines an optical axis 12 and receives an object image 14, indicated in the figure using an arrow that emits from display 4. The display may be a pixelated liquid-crystal-on-silicon (LCOS) display that can be illuminated by approximately uniform light 16, at least having approximately uniform intensity, causing the display to emit object image 14 responsive to an electronic signal 18. Initial non-uniform light 19 may be initially produced by a light source arrangement 20, and subsequently received by a homogenizer arrangement 21, which may spatially homogenize initial light 19 to produce at least approximately uniform light 16 having at least approximately uniform intensity at least with respect to illumination of the display. While the output from the homogenizer arrangement may initially propagate in a given direction 22, and while uniform light 16 may not initially be directed toward the display, this uniform light can be received by a beamsplitter 10 and redirected for incidence onto a major surface of display 4, as shown. Based on well known principles of optics, the beamsplitter may be a polarizing beamsplitter cube configured such that a majority of uniform light 16 is redirected towards the display. Furthermore, a majority of light forming object image 14, may exhibit a polarization that is appropriately oriented to pass straight through the beamsplitter for reception by imaging lens arrangement 2. Lens L2 is configured to receive object image 14 which continues to propagate through imaging lens arrangement 2 to produce a projected image 26, based on projected light 28, that exits the imaging lens arrangement from exit side 8 and can come into focus on image plane 30 at an image distance 32 indicated in the figure using a double-headed arrow. It should be appreciated that the lateral extents of the projected image can vary depending in part on image distance 32. Consistent with well known conventions, the lateral extent of the projected image may be characterized at least in part by a diagonal extent 33, indicated in FIG. 1 using a double headed arrow.

In the context of projector system 1, imaging lens arrangement 2 may limit or otherwise define various projector specifications, relating to the projected image quality, including but not limited to MTF (Modulation Transfer Function), total distortion, intensity uniformity, lateral color, depth of focus, projected image size and image brightness. Further details with respect to imaging lens arrangement 2 will be provided at appropriate points hereinafter.

For purposes of clarification, in the context of this disclosure, a given embodiment of projector system 1, can be generally considered as a high performance projector system, projecting high quality images, at least insofar as that embodiment satisfies the following conditions:
(i) Large size projected images having sufficient height and width for easy viewing at least by several people simultaneously, from a distance such that the people can avoid crowding amongst one another.
(ii) High brightness that is sufficient for easy viewing under typical conditions of ambient lighting that may be found indoors and/or outside under conditions of heavy shade.
(iii) Projected images having sufficiently low distortion, for example less than 1.0% throughout the majority of projected image 26, such that a typical person, when viewing the given projected image cannot readily discern the influence of distortion.
(iv) Sufficiently high MTF, for example greater than 30%, such that any person with normal to excellent vision, upon viewing a typical image from a close up perspective, can at least barely discern individual display pixels in the projected image.
(v) A high degree of uniformity with respect to intensity of the projected image, for example, less than 20% intensity variation at least for cases where the image is projected responsive to a uniform object image emitted by the display.

(vi) A generally desirable throw ratio (image distance/image width) for example a throw ratio in a range from 0.8:1 to 2:1, such that the enlarged projection images can be shown on a screen which is not too far, at least for practical purposes, from the projection system.

It is appreciated that satisfaction of certain ones of the foregoing projector specifications, with conventional projector systems as well as in the disclosed embodiments, may depend to a large extent on the imaging lens system. For example, projection of images satisfying a specific criterion for MTF can depend almost entirely on characteristics of the imaging lens system. However, satisfying certain other specifications may require cooperation, perhaps in complex ways, between the imaging lens system and other components of the projector system. For example, in the embodiment at hand, satisfying a predetermined specification for brightness of projected images may call for at least somewhat complex cooperation between the light source arrangement and the imaging lens system. In particular, for the projector to project predetermined large size images, while at the same time providing a predetermined high brightness, even in the case of an embodiment that utilizes a state of the art high brightness light source arrangement, it may be of benefit for the lens system to exhibit an f-number sufficiently low such that the lens system does not excessively limit the amount of light available from the light source arrangement. In some cases, the selected light source arrangement may represent the brightest source that is reasonably available and/or compatible with the configuration at hand. While the imaging lens system is not to be considered as the sole influence defining the brightness of the projector system, a low f-number imaging lens system may be regarded as a characteristic for influencing the brightness of the projector system.

Still considering cooperation between the imaging lens arrangement and other portions of the projector system, there may be yet more complex tradeoffs between various conflicting design specifications, including but not limited to the conflicting goals of achieving higher brightness while achieving a predetermined high image quality with the projection system having a lower overall system height and wide field of view. In some embodiments, enhanced MTF of the projected image can be provided in part by introducing an aperture arrangement, as part of an imaging lens system, that confines passage of the input image, as the input image propagates through the lens arrangement, to a series of aperture windows each having an aperture size and shape that is characterized in part by an aperture height. Thus, the aperture arrangement can be defined at least in part by a clear aperture associated with each one of at least a subset of the lenses. Furthermore, as will be described hereinafter, a lens having a clear aperture size may be truncated such that the clear aperture height of that lens is reduced as compared to the clear aperture width. In the case of a truncated lens, the clear aperture height may be regarded as being truncated with respect to the clear aperture size of that lens, while the clear aperture width may be considered as being the same as the clear aperture size for that lens. In embodiments where a given lens is not truncated, the clear aperture height may be the same as the clear aperture size. In cases where the clear aperture of one or more lenses, truncated or otherwise confines passage of the image, the lenses themselves can be regarded as defining at least part of the aperture arrangement. Further confinement may be provided, as part of the aperture arrangement, by introducing an aperture-stop such as a plate that defines an aperture. In any embodiment that includes an aperture-stop, the aperture arrangement may be defined in part by the clear apertures of one or more of the lenses and in part by the aperture-stop. In various embodiments, to be described at appropriate points hereinafter, the hole defined by the aperture-stop can be circular, elliptical and/or other shapes. The aperture arrangement can be configured, to enhance MTF performance such that an MTF of the output image is higher as compared to a different MTF that would be exhibited without the aperture arrangement. It is noted that the aperture arrangement, while improving MTF of the projected image, may also impose a tradeoff between brightness and MTF, and that this tradeoff can be balanced against other design considerations. It is further noted that the foregoing description is not intended as being limiting, and that the described tradeoff is but one of many possible design tradeoffs that may be considered, depending on the embodiment. Moreover, there may be other aspects and/or tradeoffs with respect to achieving a desired target value and/or range of MTF values associated with projected image 26.

As described in the background section, one common characteristic shared by many projector systems, is a capability to project an image that is significantly larger than the overall size of the projector. As each generation of handheld devices provides greater computational power than the last, but the limitations of conventional built-in displays such as small size LCD panels can be regarded as being increasingly restrictive of the full potential usefulness for devices. In this regard, high performance projector systems are described that are sufficiently compact enough and with sufficiently low height profile to fit within present and future handheld devices, such as smart phones, while still offering heretofore unseen performance.

As briefly described above, satisfaction of certain specifications associated with a high performance projector can depend at least generally on characteristics of the imaging lens system alone, while satisfying other specifications may require complex cooperation between the imaging lens system and other components of the projector system. In both cases, it is appreciated that a requirement for sufficient compactness, for a high performance projector to fit into typical handheld devices, can exacerbate practical difficulties associated with all of the listed specifications, such as, for example low f-number and short throw ratio.

Through the development of projector designs having ever lower profile and shorter focal length, it has been recognized that, absent the luxury of a reasonable and traditional amounts of space to work within, the challenges associated with short throw, high-resolution and low f-number projector design tend to reach beyond the scope of traditional projector design techniques. In this regard, traditional design approaches cannot be reasonably modified to meet the requirements at hand. It is believed that a person of ordinary skill in the art, including even the most skilled and specialized practitioners, not having access to the disclosure at hand, would in many cases regard the practical and conceptual difficulties of designing and producing such a compact high performance projector system as being sufficiently challenging as to at best render uncertain the practicality of such a proposal. Furthermore, it is believed that a person of ordinary skill in the art, in the course of such attempts at miniaturization of a conventional projector system, would be likely to introduce design compromises that would tend to degrade performance to such a degree as to render systems that are not suitable for use as compact high performance projection systems. At least in this regard, it is believed that recognition of the combined challenges and tradeoffs, and the design and production of compact, wide-angle projector systems for high-resolution displays would tend to be beyond the capability of a person of ordinary skill in the art not having this disclosure in hand.

Still referring to FIG. 1, embodiments of a wide-angle and low f-number imaging lens arrangement, for use in compact and high performance embodiments of projector system 1, having a sufficiently low height profile, defined in part by restrictions of lens height, to fit within the thickness of many current hand held devices is described. In particular, one embodiment utilizes six lenses, L1-L6 as seen in FIG. 1, each lens having a clear aperture size of no more than 10.8 mm, and each lens having a clear aperture height in a direction shown as height 34, at least generally orthogonal to the plane of the figure, as indicated in the figure by a dot. As described above, clear aperture size and height are not always the same, at least for the reason that the clear aperture height of one or more lenses may be truncated with respect to the clear aperture size of that lens. It is noted that the dot, indicated as height 34, is intended as being representative of spatial extent perpendicular to the plane of the figure, and this illustrative convention may be applied with reference to various heights throughout the remainder of this disclosure. In spite of this limited lens height, the present embodiment can be utilized in combination with available light source arrangements and display panels, also of low height profile, to project large high quality images in accordance with characteristics that are brought to light immediately hereinafter, in conjunction with an initial description of the disclosed embodiment.

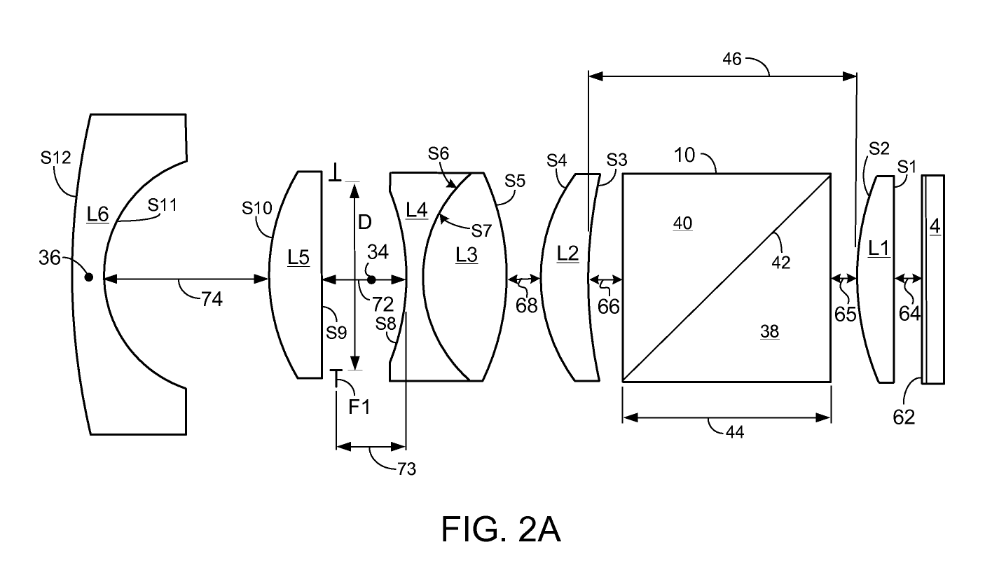

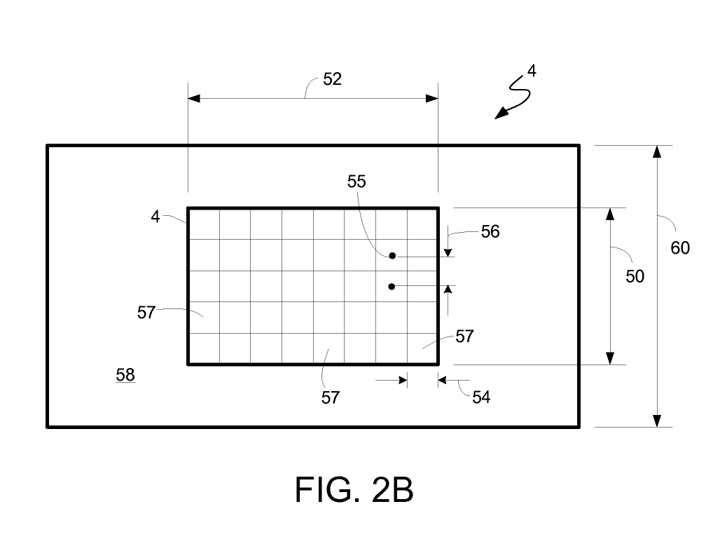

Attention is now turned to FIG. 2A, with ongoing reference to FIG. 1. FIG. 2A is a schematic diagram illustrating further details of an embodiment of high performance wide-angle imaging lens arrangement 2 of FIG. 1. For purposes of illustrative clarity, previously described beamsplitter 10 and display 4 are also included in the figure. The lens system of FIG. 2A is illustrated in an orientation consistent with that of projector 1 in FIG. 1. Imaging lens arrangement 2 includes first lens L1 located between display 4 and beamsplitter 10, and subset of lenses 3, located on the opposite side of beamsplitter 10, includes a second lens L2, followed by third lens L3, fourth lens L4, fifth lens L5 and sixth lens L6 each of which lenses is arranged progressively further from the beamsplitter 10 with the sixth lens serving as the exit side of the second lens group. The first lens L1 can be a plano-convex lens which defines a first lens surface S1 that can be a planar surface facing towards display 4, and a second, opposing lens surface S2 that can be a convex surface. The second lens L2 can be a meniscus lens which defines a third lens surface S3 that can be a concave surface facing towards display 4, and a fourth, opposing lens surface S4 that can be a convex surface facing away from the display. In one embodiment (not shown), the second lens L2 can be a bi-convex lens which defines third lens surface S3 as a convex surface facing towards display 4. In another embodiment, the second lens can be a plano-convex lens for which the third lens surface S3 may be an at least approximately planar surface facing towards the display. Third lens L3 can be a bi-convex lens which defines a fifth lens surface S5 that can be a convex surface facing towards the second lens, and a sixth lens surface S6 that can be a convex surface facing away from the second lens. Fourth lens L4 can be a bi-concave lens which defines a seventh lens surface S7 that can be a concave surface facing towards the third lens, and an eighth lens surface S8 that can be a concave surface facing away from the third lens. Sixth lens surface S6 and seventh surface S7 can have the same radius of curvature, but one can be convex and the other concave. Third lens L3 and fourth lens L4 may be cemented together to form a cemented doublet. Fifth lens L5 can be a meniscus lens which defines a ninth lens surface S9 that can be a concave surface facing towards display 4, and a tenth, opposing lens surface S 10 that can be a convex surface facing away from the display. In one embodiment, the fifth lens L5 can be a bi-convex lens which defines ninth lens surface S9 as a convex surface facing towards display 4. In another embodiment, fifth lens L5 can be a plano-convex lens for which ninth surface S9 can be an at least approximately planar surface. Sixth lens L6 can be a meniscus lens which defines an eleventh lens surface S11 that can be a concave surface facing towards the fifth lens, and a twelfth lens surface S12 that can be a convex surface facing away from the fifth lens. The first, second and sixth lenses can be composed of clear optical plastic, and the third, fourth and fifth lenses can be composed of clear optical glass. In one embodiment, the first lens can be composed of clear optical glass. In another embodiment, the fifth lens can be composed of clear optical plastic. The optical material composition of each lens, in this embodiment, can be characterized at least in part by an index of refraction and an Abbe number, with the index of refraction of the first lens of at least approximately 1.49, and the Abbe number of the first lens being at least approximately 55.3; the index of refraction of the second lens of at least approximately 1.49 with an Abbe number of at least approximately 55.3; the index of refraction of the third lens of at least approximately 1.71 with an Abbe number of approximately 53.8, the index of refraction of the fourth lens of at least approximately 1.85 with an Abbe number of approximately 23.8, the index of refraction of the fifth lens of at least approximately 1.85 with an Abbe number of approximately 23.8, and the index of refraction of the sixth lens can be at least approximately 1.49 with an Abbe number of at least approximately 55.3. It should be appreciated that the foregoing index values and Abbe numbers are not intended as being limiting, and may vary in ways that are fully consistent with the scope of this overall disclosure. By way of non-limiting example, the index of refraction of the first lens can have a value from 1.48 to 1.84; the index of refraction of the second lens can have a value from 1.48 to 1.60; the index of refraction of the third lens can have a value from 1.60 to 1.82; the index of refraction of the fourth lens can have a value from 1.62 to 1.85, the index of refraction of the fifth lens can have a value from 1.50 to 1.85 and the index of refraction of the sixth lens can have a value from 1.48 to 1.65. Also by way of non-limiting example, the Abbe value of the first lens can have a value from 23 to 84; the Abbe value of the second lens can have a value from 40 to 64; the Abbe value of the third lens can have a value from 41 to 64; the Abbe value of the fourth lens can have a value from 21 to 35, the Abbe value of the fifth lens can have a value from 21 to 39 and the Abbe value of the sixth lens can have a value from 42 to 66.

It is noted that sixth lens L6, can be configured with a clear aperture size of 10.8 mm, greater than the clear apertures associated with all of the other lenses, with clear aperture height 36 of L6 extending at least generally orthogonal to the plane of the figure. As described above, the clear aperture height of one or more lenses can be truncated with respect to the clear aperture size of that lens. In one embodiment, a clear aperture height 36 of lens L6 can be truncated to a value of approximately 7.0 mm, while the diameters of other lenses (L1 to L5) can be less than and/or equal to 7.0 mm. It is noted that here and throughout the remainder of the disclosure and the appended claims, the term “height” is to be considered as referring to a direction and/or orientation that is at least approximately aligned with height 34 indicated in FIG. 2A. As described previously, the clear apertures of the lenses, at least for each one of a subset of the lenses, forms at least a portion of the aperture arrangement and can confine the image, as it propagates through the lens arrangement, sufficiently to improve MTF as compared to a lens arrangement that does not incorporate the aperture arrangement.

A radius of curvature can be at least approximately assigned to each surface in accordance with table 1. With respect to the embodiment at hand, it is noted that the first, second and sixth lenses are aspherical lenses, with S2, S3, S4, S11, and S12 being even aspherical surfaces. As the name “aspherical” clearly designates, based on well established terminology, aspherical lens surfaces explicitly deviate from traditional spherical lens surfaces. It should be understood by a person of ordinary skill in the art that the associated radii listed in table 1, can be readily interpreted in the somewhat general sense relating to an overall lens approximate performance, and has been provided for purposes of enhancing the initial understanding of the reader. A complete specification of each even aspherical lens surface, however, is provided immediately hereinafter. It is noted that the third, fourth and fifth lenses in this embodiment are spherical lenses, such that the table entries for surfaces S5, S6, S7, S8, S9 and S10 can be regarded as fully specifying these lens surfaces, at least to an approximation consistent with the number of decimal places associated with each entry.

TABLE 1

| Surface | RADIUS R (in mm) |
|---|---|
| S1 | Infinity |
| S2 | −9.578 |
| S3 | −763.625 |
| S4 | −6.478 |
| S5 | 7.995 |
| S6 | −4.708 |
| S7 | 4.708 |
| S8 | 8.605 |
| S9 | −1288.98 |
| S10 | −7.404 |
| S11 | −2.663 |
| S12 | −11.461 |

Based on well known conventions, each one of even aspherical surfaces S2, S3, S4, S11 and S12 can be completely specified, at least to an approximation, based on equation 1, in which r represents a distance from the optical axis on which each surface profile is assumed to be centered. The apex of each aspherical surface is assumed to intersect the optical axis, and for each value of r throughout the lens surface, Z sag can be interpreted, in accordance with well known optics conventions, as the distance along the optical axis from the apex.

$$Z sag = \frac{{cr}^{2}}{1 + \sqrt{1 - ( k + 1 ) {c}^{2} {r}^{2}}} + {A}_{4} {r}^{4} + {A}_{6} {r}^{6} + {A}_{8} {r}^{8} + {A}_{10} {r}^{10} \qquad ( Eq . 1 )$$

For surfaces S2, S3, S4, S11 and S12, the values of k, A₄, A₆, A₈ and A₁₀ can be designated, at least to an approximation, in accordance with table 2. The value of c is defined as the inverse of the approximate lens radius according to the equation c=R⁻¹ with R being the radius of each lens surface as specified in TABLE 1, and k is a conic constant for that lens surface.

TABLE 2

| Surface # | K | A₄ | A₆ | A₈ | A₁₀ |
|---|---|---|---|---|---|
| S2 | 0.549 | 1.1875E−3 | −1.1931E−4 | 4.1099E−6 | 1.4891E−7 |
| S3 | 208.268 | −1.5236E−3 | −3.1473E−5 | 5.2039E−6 | −4.2806E−7 |
| S4 | 0.966 | 1.0395E−4 | 5.7902E−6 | 2.1569E−6 | −1.7890E−7 |
| S11 | −0.815 | 3.4682E−3 | −2.3936E−4 | 9.8534E−6 | −1.7833E−7 |
| S12 | −51.346 | 1.4439E−4 | −1.2933E−5 | 3.5803E−7 | −3.7376E−9 |

Considering FIG. 2A with reference to FIG. 1, the beamsplitter can be a polarizing beamsplitter cube 10 formed of two right angle prisms, including a first prism 38 and a second prism 40, facing one another to form an interface 42 therebetween. In the embodiment at hand, beamsplitter cube 10 has a length 44, along the optical axis, as indicated in the figure using a double-headed arrow, of 7 mm. In selected embodiments, both of the prisms can have the same index of refraction having a value n. In one embodiment, each of the prisms can have an index of refraction n having a value of at least approximately 1.85. In another embodiment, the index n of the prisms can be at least approximately 1.51. Interface 42 may be a polarizing reflector such as a polarizing coating or a polymeric polarizing film. As described previously with reference to FIG. 1, beamsplitter interface 42 can be arranged such that a majority of uniform light 16 is redirected towards the display. Furthermore, a majority of object image 14 can be appropriately polarized to pass straight through the beamsplitter for reception by imaging lens arrangement 2. While the beamsplitter cube of these embodiments may not include any curved lens surfaces integral thereto, at least some aspects of lens-like performance, such as refractive index and dispersion, can be expected to cause the beamsplitter cube to influence overall performance characteristics of the projected image to a degree that is not to be regarded as insignificant, and the lenses of this embodiment can be configured to cooperate with one another and with the beamsplitter cube to account for this influence so as to achieve high performance imaging characteristics, at least selected ones of which are described in detail hereinafter.

As one characteristic of disclosed embodiments, imaging lens arrangement 2 can be configured with a distance 46 between the first lens and the second lens, that is at least as long as length 44 of the beamsplitter cube (FIG. 2A). As described previously, the beamsplitter cube can be arranged for cooperation with the homogenizer arrangement and the light source arrangement to provide for illumination of the display with light having sufficiently high brightness and uniformity to provide for high performance based at least on the conditions set forth previously. Therefore, imaging lens arrangement 2 can be customized based on a given beamsplitter cube. Moreover, satisfying the immediately forgoing characteristic with respect to distance 46, while maintaining lens height as not exceeding 2.4 times the display height, is considered as a significant recognition in producing a low-profile and high performance projector system, especially in view of an embodiment that can include no more than six lenses.

As another characteristic of the disclosed embodiments, the imaging lens arrangement can exhibit an effective focal length having a value f. Furthermore, lenses L1, L2, L3, L4, L5 and L6 can exhibit focal lengths f₁, f₂, f₃, f₄, f₅ and f₆, respectively. A person of ordinary skill in the art can readily determine these focal lengths based on the descriptions at hand. It should be appreciated that the lens configurations described are in no way intended as being limiting, and that various lens configurations, having different focal lengths, can be accommodated in ways that are fully consistent with the scope of this overall disclosure. For example, the lenses can be configured such that f₁ satisfies the relationship 2.2 f<f₁<9.1 f, f₂ satisfies the relationship 1.5 f<f₂<6.3 f, f₃ satisfies the relationship 1.8 f<f₃<7.2 f, f₄ satisfies the relationship 1.1 f<−f₄<3.9 f, f₅ satisfies the relationship 1.2 f<f₅<4.8 f, and f₆ satisfies the relationship 0.9 f<−f₆<3.8 f.

Attention is now directed to FIG. 2B, which is a diagrammatic view, in elevation, showing one embodiment of display 4. In the illustrated embodiment, and by way of non-limiting example, display 4 may be a high performance microdisplay presently available through Micron Technology Inc., as model number MT7PQHBCBBA-A1, which is a grey scale ferroelectric liquid crystal on silicon (FLCOS) pixel array having a display height 50 of approximately 2.97 mm and a display width 52 of approximately 5.28 mm as shown in FIG. 2B using double-headed arrows. This embodiment is pixelated, having approximately 518,400 pixels. In one embodiment, the pixels can be arranged in a side by side rectangular array of 960 pixels by 540 pixels, based in part the qHD standard, each having a pixel size 54 of at least approximately 5.5 microns. Each one of the pixels can define a center point 55 thereof, and the pixels can be arranged in side-by-side relationships with one another such that the display defines a pixel pitch 56 as a distance between the center points of any two adjacent ones of the pixels. It can be appreciated that for the case of the qHD embodiment, the pixel pitch can have a value of approximately height divided by 540. Due to illustrative constraints, FIG. 2B shows only a limited number of pixels with several pixels designated by reference number 57. It is noted that the display can be supported by a display substrate 58, and that the substrate can be larger than display 4. However, as will be described in detail hereinafter, the lenses in this embodiment can be limited in size such that for each of the lenses, clear aperture size of each lens can be less than 10.8 mm, while the height can be approximately less than 2.4 times the display height of display 4. Furthermore, as described above, one or more of the lenses can be truncated such that the clear aperture height of that lens is reduced as compared to its clear aperture size. At least in view of the challenges associated with achieving a low overall height profile, for an embodiment of the imaging lens arrangement as well as the projector system as a whole, a package height 60 of the display substrate can be limited to less than 7.2 mm. The display substrate can further serve as a support structure for various electronics circuits (not shown) associated with control and operation of the display, including control logic, power management circuitry, display timing control and a video processor engine. One or more of these electronic circuits can be configured to receive electronic signal 18 (FIG. 1). As will be described hereinafter, the display can be configured to cooperate with the light source arrangement to provide the projected color image in a way that is based at least in part on dynamic sequential display technology.

It should be appreciated that display dimensions (2.97 mm height by 5.28 mm width), as well as the corresponding lenses, aperture sizes and dimensions have been selected for descriptive purposes and are not intended as being limiting. In this regard, various sizes, lens spacings, and dimensions can be accommodated in ways that are fully consistent with the scope of this overall disclosure. For example, as will be described in greater detail hereinafter, a person of ordinary skill in the art, having this disclosure in hand, can readily scale the imaging lens arrangement to provide high quality images emitted at least from any one of many different displays including a display having a larger display size. That is, the concepts that have been brought to light herein can be readily applied at least to larger scale arrangements, and performance characteristics associated with larger, scaled up embodiments can generally be expected to meet or exceed the characteristics associated with embodiments disclosed herein. Likewise, the teachings can be applied with respect to downward scaling and may serve as a basis of further advancement at smaller scale. In one embodiment, the display can be configured as a 720 p display with the pixels arranged in a rectangular 720 pixel by 1080 pixel array with 720 pixels along the height of the display, and 1080 pixels along the width of the display, and this display can exhibit a pixel pitch having a value that is at least approximately H divided by 720. In various embodiments, including but not limited to qHD and 720 p embodiments, the arrangement can be readily scaled to accommodate a display having a pixel pitch greater than 4 um.

With reference to FIG. 2A, it is noted that display 4 of the disclosed display embodiment can be overlaid with a thin optical glass cover 62 in layered contact therewith, having a cover thickness of at least approximately 0.7 mm and an index of refraction of at least approximately 1.52 with an Abbe number of at least approximately 64. The display can be positioned so that cover 62 is located along the optical axis with a spacing 64, between the first surface of the lens L1 and the cover, of approximately 0.5 mm. It is noted, as is the case with regard to the Micron model MT7PQHBCBBA-A1 display, that the glass cover can be an integral part of the display, provided at least in part for sealing and protecting the display. The glass cover of the present embodiment need not include any curved lens surfaces integral thereto, yet certain aspects of lens-like performance, such as dispersion and/or refraction can nevertheless cause the glass cover to influence overall performance characteristics of the projected image. Accordingly, the lenses of the embodiment at hand can be configured to cooperate with one another, and with the glass cover, accounting for this influence in order to achieve high performance imaging characteristics that are described in detail hereinafter.

Having provided detailed descriptions of each of the six lenses of this embodiment, with further descriptions relating at least to optical and/or imaging properties of the beamsplitter cube and the display, attention is again directed to FIG. 2A, which uses a series of double-headed arrows to indicate spacing between each lens. In the embodiment at hand, a spacing 65, between second lens surface S2 and the beamsplitter cube, is approximately 0.6 mm, a spacing 66, between the beamsplitter cube and third lens surface S3, is approximately 1.66 mm; a spacing 68, between fourth lens surface S4 and fifth lens surface S5, is approximately 0.2 mm; a spacing 72, between eighth lens surface S8 and ninth lens surface S9, is approximately 3.02 mm, and a spacing 74 between tenth lens surface S10 and eleventh lens surface S11, is approximately 9.69 mm. It should be appreciated that these spacings are not intended as being limiting, and can vary in ways that are fully consistent with the scope of this overall disclosure. For example, spacing 64 can vary from 0.2 mm to 2.5 mm, spacing 65 can vary from 0.5 mm to 5.1 mm, spacing 66 can vary from 0.4 mm to 6 mm, spacing 68 can vary from 0.1 mm to 3 mm, spacing 72 can vary from 2.1 mm to 4.5 mm, and spacing 74 can vary from 4.0 mm to 15 mm.

The imaging lens arrangement further includes aperture-stop F1 having a diameter D as indicated in FIG. 2A. Furthermore, as described above, the clear aperture heights of the lenses can cooperate with one another to define an aperture arrangement that confines passage of the input image, as the input image propagates through the lens arrangement, to a series of aperture windows each having an aperture size and shape that can be characterized in part by an aperture height. As will be described in greater detail at appropriate points hereinafter, the MTF of the output image, projected through the plurality of lenses, can be higher as compared to a different MTF that would be exhibited without the aperture arrangement. In this embodiment, aperture-stop F1 is disposed between lenses L4 and L5, spaced by an aperture spacing 73 of at least approximately 2.82 mm along the optical axis from lens surface S8 and defines a circular aperture opening, centered on the optical axis and having a diameter of approximately 6.6 mm. As described previously with respect to lenses, the aperture-stop can have an aperture size (for example diameter) and can be truncated such that the aperture-stop exhibits an aperture height that is reduced as compared to the aperture diameter.

Again considering FIG. 1, in conjunction with FIG. 2A, at last some of the lenses can be supported for motion 63, as indicated in FIG. 1 using a double-headed arrow, such that the lens assembly is movable within a range of lens positions along the optical axis to provide an adjustable focus of the projected image for varying the image distance, within a corresponding range of image distances. It is noted that while the throw ratio associated with the present embodiment is approximately 0.8:1, a person of ordinary skill in the art, having this disclosure in hand, can readily modify the embodiments to provide for throw ratios from 0.6:1 to 1.5:1. These throw ratios allow the projected image to be focused such that the image plane can be located within in a range of image distances between 100 mm and 1100 mm to produce images having a corresponding range of diagonal image sizes between 6″ and 62″, respectively.

Having disclosed details of an embodiment of an imaging lens arrangement suitable for use as part of a high performance projection system, selected characteristics of this embodiment, such as f-number, MTF, total distortion, relative illumination and lateral color will now be described.

As described previously, for the projector to project predetermined large size images, while at the same time providing a predetermined high brightness, even in the case of an embodiment that utilizes a state of the art high brightness light source arrangement, it may be of benefit for the lens system to exhibit an f-number sufficiently low such that the lens system does not excessively limit the amount of light available from the light source arrangement. In the context of compact high performance projectors, it is recognized that it may be desirable for the imaging lens arrangement to exhibit an f-number of no more than 1.7. In this regard, it is noted that the embodiment at hand exhibits an f-number of 1.5, at least to an approximation.

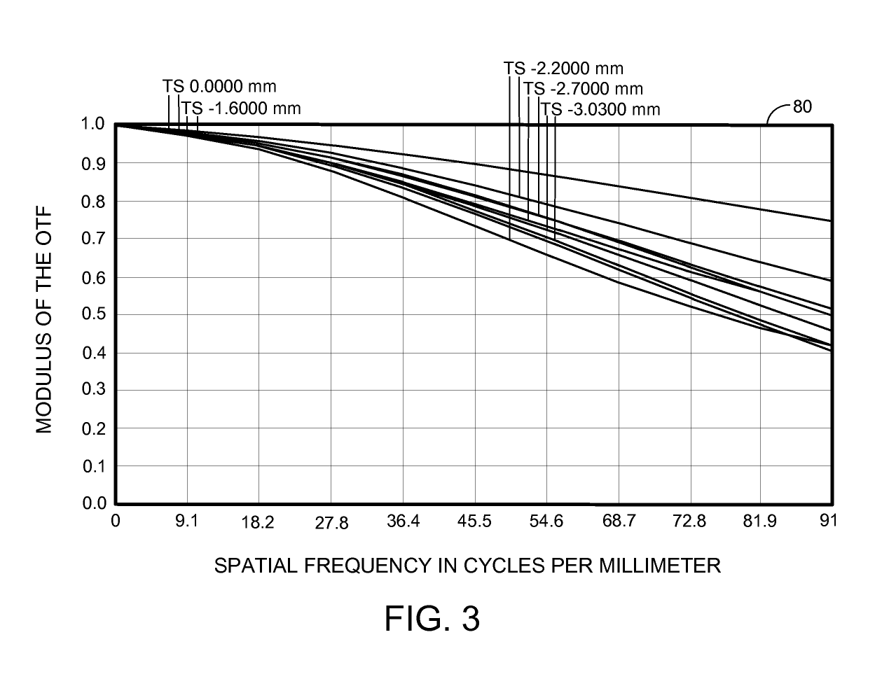

Attention is now turned to FIG. 3, which is a graph, generally indicated by the reference number 80 plotting MTF over a range of values of spatial frequency. Graph 80 includes a horizontal axis oriented horizontally and representing spatial frequency in cycles per mm, and a vertical axis representing polychromatic diffraction MTF. It is noted that for purposes of descriptive brevity, polychromatic MTF may hereinafter be referred to as MTF. In the context of imaging lens arrangement 2, based on well established conventions, each value of spatial frequency represents a spatial frequency of one or more features associated with the input object image emitted from the display, while the plotted values of MTF can be characterized with respect to the projected color image. It is noted that the MTF values plotted in graph 80, can be generated using one or more of a number of commercially available ray tracing software applications that are commonly utilized for characterizing designs of imaging optical systems.

Graph 80 includes twenty plots of MTF, each of which is labeled, based on well established conventions, as corresponding to a given field of view from the center of a display. Furthermore, each plot is labeled with a “T” or “S” indicating that the plot is associated with the tangential or sagittal plane of the imaging lens arrangement. For reference purposes, each plot may be referred to according to the foregoing designations. Based on well established conventions, a given value of spatial frequency can be at least generally ascribed to a given feature size associated with part of an object image. In general, as will be appreciated by a person of ordinary skill in the art, higher values of spatial frequency correspond to smaller feature sizes. For example, in the case where the given feature is a pixel having a given pixel size, then the smaller the pixel size, the higher the spatial frequency associated therewith. Similarly, based on well established conventions, the spatial frequency may be referred to in relation to the pixel pitch of a given display. The spatial frequency associated with the pixel size and or pixel pitch, for a given display, may be considered as particularly significant, since the pixel size constitutes the smallest feature detail produceable by that display.

It is noted that the plots of graph 80 can be considered as accounting for color influence within a visible spectrum range using a light source arrangement including at least one blue source centered at approximately 465 nm wavelength; at least one green source centered at approximately 525 nm wavelength; and at least one red source centered at approximately 615 nm wavelength. The weighting factors for the foregoing RGB light source arrangement can be 1:3:1 respectively. Thus, plots of graph 80 can be regarded as displaying polychromatic MTF for color images, in accordance with the foregoing wavelength weighting.

For an embodiment with pixels each having pixel size of 5.5 microns, the corresponding spatial frequency associated with the display is approximately 91 cycles per millimeter. Graph 80 indicates that imaging lens arrangement 2 can be characterized as having polychromatic MTF values computed as being greater than 40% at this spatial frequency, and for any spatial frequencies below this value. This computed performance is considered as exceeding MTF requirements associated with high performance projection as described previously. (As described above, the MTF values plotted in graph 80, can be generated using one or more of a number of commercially available ray tracing software applications, such as Zemax®.)

The aperture arrangement, defined in part by clear apertures of the lenses and in part by the aperture-stop indicated in FIG. 2A as F1, can be configured to confine passage of the input image, as the input image propagates through the plurality of lenses, to within one or more aperture windows each window having a size and shape that is characterized in part by a height that is less than the projector height. It is noted that graph 80 is representative of MTF of disclosed embodiments only insofar as each embodiment includes the aperture arrangement, and that the MTF as plotted can be higher, at least for a range of spatial frequencies, as compared to a different MTF for a different embodiment that does not include the aperture arrangement. As described previously, the aperture arrangement, while increasing MTF, can cause a limited decrease in brightness, that is considered as acceptable, at least for portions of any image projected by the imaging lens arrangement. With respect to such embodiments, it is believed that excellent overall projector performance can nevertheless be provided in view of the overall teachings herein. It is noted that the described use of the aperture arrangement, at least in the context of trading MTF against projector height, is not to be considered in any way as limiting, and a designer may choose to provide a different aperture arrangement, including different clear aperture heights for one or more of the lenses, and/or including a different aperture-stop at a different position along the optical axis, or may otherwise configure the aperture arrangement according to numerous variations that will be apparent to any person of ordinary skill in the art.

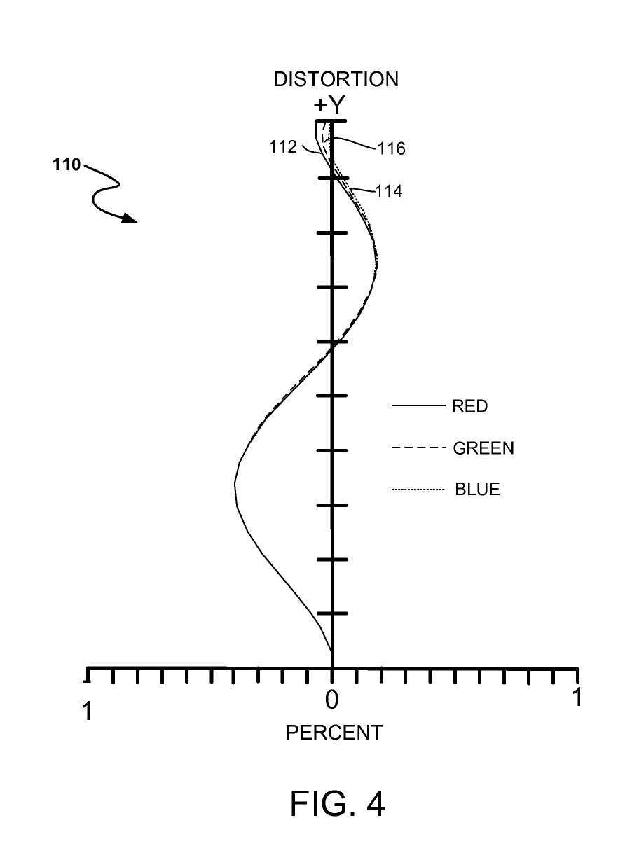

Attention is now directed to FIG. 4, which is a graph, generally indicated by the reference number 110, that plots image distortion associated with various positions on display 4 (FIG. 2B). Based on well known modeling and measurement techniques, and in accordance with well established conventions for characterizing projection systems, a distortion of a projected image can be characterized with respect to projected images associated with different portions of display 4. Graph 110, generated using ray tracing software includes a vertical axis representing a range of display positions, and a horizontal axis corresponding to percentage distortion. Graph 110 includes plots 112, 114, and 116 corresponding to colors red, green and blue, respectively. Plots 112, 114, and 116 indicate that imaging lens arrangement 2 can be characterized as exhibiting a total distortion of less than 0.5%, which is considered as being fully consistent with high performance projection as described previously.

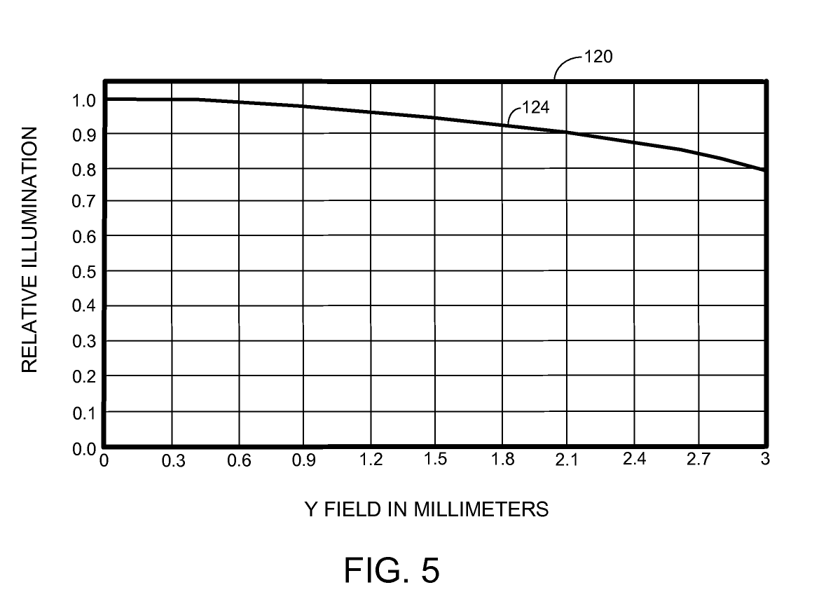

Attention is now turned to FIG. 5, in conjunction with FIG. 1, which is a graph 120 plotting relative illumination associated with a range of positions in the projected image. In accordance with well established conventions, relative illumination can be characterized, for a particular projected image that can be generated responsive to a uniform object image having approximately uniform intensity. In this case, the particular projected image may exhibit an intensity distribution, as intensity variation related to a reference value of intensity at centrally located reference portion 122 (FIG. 1) of the projected image, indicated in FIG. 1. The uniform intensity can be generated based on an electrical signal 18, provided as a test signal, that causes each pixel of the display to emit light of the same intensity as all other pixels. Graph 120 includes a plot 124, produced using Zemax®, based in part on a set of input data representative of a uniform object image corresponding to uniform white light, and further includes a horizontal axis corresponding to various positions in the projected image, distributed across the diagonal 33, from a central point 122 to an outer corner of the image, and a vertical axis showing relative percentage of intensity variation. It is noted that the intensity drops off somewhat for locations that are progressively further from the central reference portion of the projected image, such that an outer peripheral region of the projected image is slightly dimmer as compared to that of the central region. In terms of art, this effect is generally referred to as vignetting, and while a small and/or acceptable degree of vignetting has been introduced in order to provide for higher MTF and smaller component size, higher levels of vignetting can cause images to develop a noticeable tunnel-like appearance generally considered unacceptable except in cases when it may be intentionally introduced for artistic purposes and/or for use as an easily noticeable special effect. It is noted that vignetting, noticeable or otherwise, can be increased with a decrease in aperture size and/or height, and can be mitigated with an increase in aperture size and/or height. In the case of imaging lens arrangement 2, a decrease in diameter and height of L1, L2, L3, L4, L5 and L6 may tend to increase vignetting such that relative illumination may tend to exhibit a greater degree of variation as compared to the disclosed embodiment, while an increase in these diameters and heights can tend to decrease vignetting such that relative illumination can tend to exhibit a lesser degree of variation. As described above, it is recognized that variation in clear aperture size and/or height influences a number of performance and projector dimension tradeoffs, with smaller aperture size and/or height influencing MTF and projector height in a beneficial way, while imposing a design tradeoff that includes some extent of performance compromise with respect to brightness and vignetting. In this case, a certain degree of degradation with respect to vignetting can be acceptable for a predetermined improvement with respect to MTF and projector height.

It is submitted that the performance characteristics, associated with disclosed embodiments of imaging lens arrangement 2, implement a “high performance” projector system that can be characterized at least by (i) MTF greater than 40% for all spatial frequencies at and below the frequency associated with the display pixel pitch, (ii) total distortion of less than 1.0%, (iii) variation in intensity of less than 20%, and (iv) f-number as low as 1.5. Moreover, embodiments of imaging lens arrangement 2 can exhibit such high performance in conjunction with low height profile having lens heights less than 2.4 times the display height, while providing a sufficiently large separation between lens L1 and lens L2 to accommodate a beamsplitter cube. Furthermore, these attributes have been implemented in a lens configuration that has short focal length and provides wide field of view.

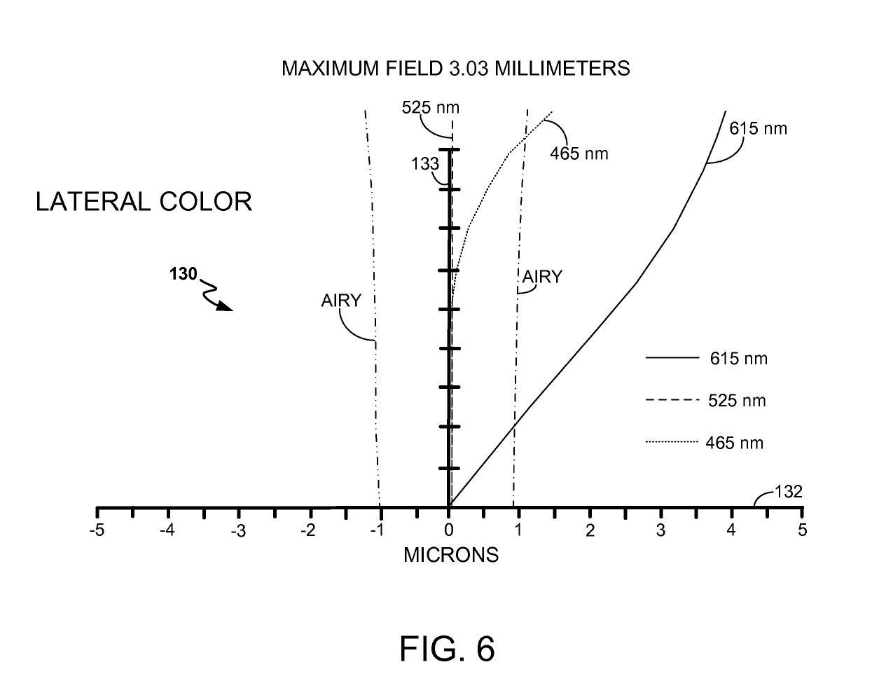

Attention is now directed to FIG. 6, which is a graph, generally indicated by the reference number 130 that plots lateral shifts of chief ray intercepts, evaluated at display 4, for various wavelengths relative to one reference wavelength, based on well known conventions for graphically characterizing chromatic aberration of optical imaging systems. Horizontal axis 132 represents lateral color in microns and the vertical axis corresponds to different field positions spanning the display 4, from the center to the outer corner along the diagonal. Graph 130 indicates that the lateral color of wavelengths 465 nm and 615 nm, relative to a reference wavelength of 525 nm, are less than 4 um.

Having described embodiments with respect to wide angle low f-number imaging arrangements, including various performance characteristics thereof, a number of further embodiments will be described immediately hereinafter.

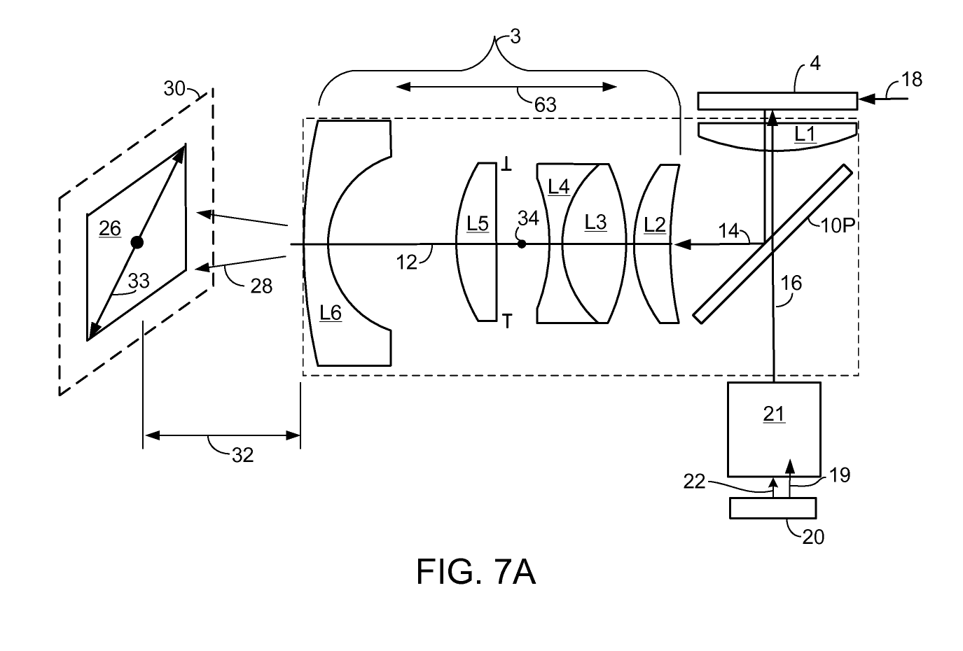

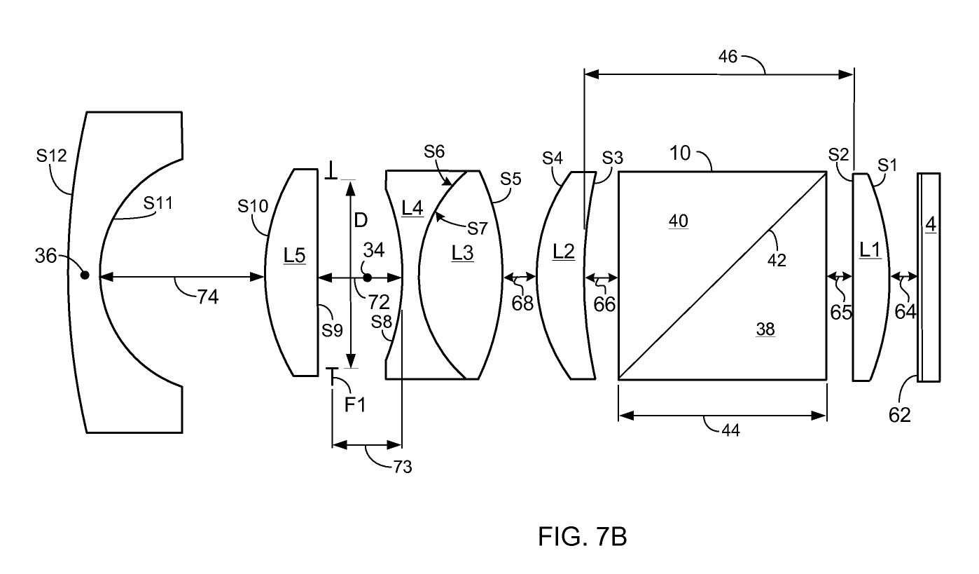

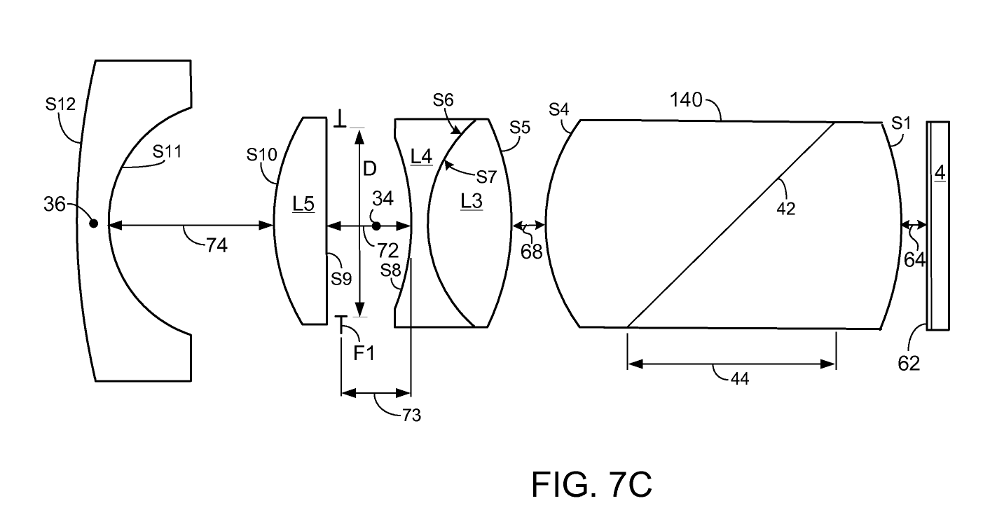

Attention is now turned to FIG. 7A, with ongoing reference to FIG. 1. FIG. 7A is a diagrammatic view, in elevation, which illustrates an embodiment of projector system 1 wherein a reflective polarizer plate 10P serves as the beamsplitter arrangement. The reflective polarizer is arranged in manner that reverses the order with respect to transmission and reflection therethrough, as compared with the embodiment of FIG. 1, such that the polarized light from light source can directly illuminate the display, while the object image can be reflected by the polarizer plate towards the second lens group.

Attention is now turned to FIG. 7B, with ongoing reference to FIG. 1. FIG. 7B is a diagrammatic view, in elevation, which illustrates an embodiment of projector system 1 in which the planar surface of field lens L1 faces towards the PBS cube. This lens can be a spherical lens formed of clear optical glass and/or plastic. Based in part on this orientation of the field lens, a person of ordinary skill in the art, having this disclosure in hand, may readily modify various other aspects of the design, including making appropriate adjustments to selected lens radii and or other parameters such as lens materials and lens-to-lens spacings, for achieving performance characteristics that are at least generally consistent with the foregoing descriptions.

Attention is now turned to FIG.7C, with ongoing reference to FIG. 7B and FIG. 1. FIG. 7C is a diagrammatic view, in elevation, illustrating an embodiment of projector system 1 wherein the first and second lenses of FIG. 7B can be integrated with the PBS cube, to form a lensed PBS cube 140, at least for purposes of reducing cost by way of a reduction in the number of lenses. This integrated component can be formed of clear optical glass and/or plastic. A lens surface S1 can define the input end of the imaging lens arrangement, and a lens surface S4 can be provided at an opposing end of the lensed PBS cube, as illustrated in FIG. 7C. Lens surfaces S1 and S4 can be configured to cooperate with one another to refract object image 14 (FIG. 1), as it passes through the lensed PBS cube, in a manner that is at least approximately similar to refraction provided by cooperation between lenses L1, L2, and beamsplitter 10 in the configuration of FIG. 7B. Based in part on this arrangement with respect to the first and second lenses, a person of ordinary skill in the art, having this disclosure in hand, may readily modify various other aspects of the design, including making appropriate adjustments to selected lens radii and or other parameters such as lens materials and lens-to-lens spacings, for achieving performance characteristics that are at least generally consistent with the foregoing descriptions.

In view of the foregoing, imaging lens arrangements have been described that are suitable for use in a short-throw low-profile projection system that incorporates a state-of-the-art high resolution miniature display. Embodiments of the projection lens arrangement can cooperate at least with these components to provide for high performance projection as set forth above, including providing for high brightness, high MTF, low distortion, a low degree of chromatic aberration and a high degree of intensity uniformity.

As described previously, it is considered that design and production of any compact projector system, having sufficiently low profile to fit within the peripheral outline of today's and future handheld devices while providing for high performance, such as high resolution and efficiency, introduces a combined set of challenges and design tradeoffs that cannot be reasonably addressed merely by miniaturization based on traditional projector systems and/or traditional imaging lens arrangements. Furthermore, recognizing and addressing the full scope of these combined challenges and tradeoffs is well beyond the capability of persons of ordinary skill in the art.

The foregoing descriptions are in no way intended as being limiting, and the teachings of the present disclosure can be readily practiced in larger scale devices. For example, the host device can be a stand-alone module and/or a laptop computer, as opposed to a mobile phone that imposes severe height constraints.

In general, regardless of extent of upward scaling, any high performance characteristics including but not limited to MTF>40% and total distortion<1.0%, can remain at least generally unchanged for each of a range of scaled-up embodiments. It is noted that for purposes of descriptive clarity, a number of features associated with the disclosed embodiments have been described in a way that is independent of scale and that readily applies to a range of differently scaled embodiments. For example, the requirement that the ratio of lens height to display height does not exceed 2.4, can remain unchanged for each of a range of scaled up embodiments. As another example, the separation between lens L1 and lens L2 is characterized as being at least sufficiently long to accommodate a beamsplitter such that the beamsplitter at least fits between the first lens and the second lens.

The foregoing description of embodiments of the invention has been presented for purposes of illustration and description. It is not intended to be exhaustive or to limit embodiments of the invention to the precise form or forms disclosed, and other modifications and variations may be possible in light of the above teachings wherein those of skill in the art will recognize certain modifications, permutations, additions and sub-combinations thereof.

What is claimed is:

1. An imaging lens arrangement, for use in an image projector system with a display having a display height, of value H, and a display width, of value W, that is greater than the display height, the display including a plurality of pixels each having a pixel size, the imaging lens arrangement comprising:
a plurality of lenses, defining an optical axis, an entrance side and an exit side, and including a first lens and a subset of lenses, all of which lenses are configured to cooperate with a given beamsplitter that is positioned between the first lens and the subset of lenses for receiving and imaging an object image that emits from the display and is received at the entrance side to serially pass through the first lens, the beamsplitter, and then through the subset of lenses at least generally along the optical axis, to produce a projected image from the object image that exits the imaging lens arrangement from the exit side, and each lens has a clear aperture height that is at least generally aligned in the same direction as the display height, and for each of the lenses, the clear aperture height of that lens exceeds the display height by no more than 2.4 times the display height, and the imaging lens arrangement is at least generally object space telecentric and exhibits a low f-number of no more than 1.7.

2. The imaging lens arrangement of claim 1 further comprising for any portion of the projected image within the image plane, the imaging lens arrangement is configured such that an image quality at that portion is characterized by an image distortion, and the total distortion associated with any portion of the projected image is less than 1.0%.

3. The imaging lens arrangement of claim 1 further comprising the lenses configured to cooperate with one another to define an image plane at which the projected image is at least approximately focused, which image plane is located at an image distance from the exit side of the lens arrangement,
wherein each one of the pixels defines a center point thereof, and the pixels are arranged in side by side relationships with one another such that the display defines a pixel pitch as a distance between the center points of two adjacent ones of the pixels, and for any portion of the projected image within that image plane, the imaging lens arrangement provides an image quality at that portion that can be characterized at least in part by a value of polychromatic diffraction MTF, evaluated at the display, that is greater than 30% at a spatial frequency corresponding to the pixel pitch of the display.

4. The imaging lens arrangement of claim 3 further comprising a high resolution display serving as the display, having a pixel pitch with a value from at least approximately 4 um to at least approximately 9 um.

5. The imaging lens arrangement of claim 4 further comprising the display configured as a qHD display with the pixels arranged in a rectangular 540 pixel by 960 pixel array with 540 pixels along the height of the display, and 960 pixels along the width of the display, and the display exhibits a pixel pitch having a value that is at least approximately H divided by 540.

6. The imaging lens arrangement of claim 4 further comprising the display configured as a 720 p display with the pixels arranged in a rectangular 720 pixel by 1080 pixel array with 720 pixels along the height of the display, and 1080 pixels along the width of the display, and the display exhibits a pixel pitch having a value that is at least approximately H divided by 720.

7. The imaging lens arrangement of claim 3 wherein the beamsplitter is a beamsplitter cube having a length that is at least 1.1 times the width of the display, and the imaging lens arrangement including a second lens that serves as an input of the subset of lenses that is arranged to receive the object image from the beamsplitter cube, and the second lens is spaced apart from the first lens at a distance along the optical axis that is at least as long as the length of the beamsplitter cube.

8. The imaging lens arrangement of claim 3 further comprising an aperture arrangement that confines passage of the input image, as the object image propagates through the plurality of lenses, to within one or more aperture windows, such that the MTF of the output image produced by the plurality of lenses, is higher as compared to a different MTF that would be exhibited without the aperture arrangement.

9. The imaging lens arrangement of claim 8 wherein the aperture arrangement includes an aperture-stop arrangement that defines an aperture window having a circular shape.

10. The imaging lens arrangements of claim 9 wherein the aperture-stop arrangement is positioned following a one of the plurality of lenses, and the circular shape has a diameter of at least approximately 6.6 mm.

11. The imaging lens arrangement of claim 8 further comprising a configuration of the lenses such that for a uniform input image, at least having approximately uniform intensity, a central portion of the projected image exhibits a reference value of intensity, and the projected image exhibits spatial intensity variation, throughout all lateral positions thereof, of less than 20% of the reference value of intensity.

12. The imaging lens arrangement of claim 3 wherein at least one of the subset of lenses is a movable lens that is movable within a range of lens positions along the optical axis to vary the image distance, based at least in part on the lens position, within a corresponding range of image distances, to provide an adjustable focus of the projected image.

13. The imaging system of claim 12 wherein the movable lens is configured for movement at least between a first position and a second position, and the plurality of lenses cooperate with one another such that with the movable lens in the first position, the corresponding image plane is located at a first image distance and the projected image focused thereon exhibits a diagonal size less than six inches; and
with the movable lens in the second position, the corresponding image plane is located at a second image distance, longer than the first image distance, and the projected image focused thereon exhibits a diagonal size of more than sixty inches.

14. The imaging lens arrangement of claim 3 wherein the plurality of lenses comprises six lenses, including the first lens, a second lens that serves as an input of the subset of lenses for receiving the object image from the beamsplitter, followed by a third lens, a fourth lens, a fifth lens, and a sixth lens spaced apart along the optical axis such that the sixth lens serves as the exit side of the imaging lens arrangement.

15. The imaging lens arrangement of claim 14 wherein:
the first lens is a plano-convex lens having a positive lens power such that the field lens is characterized at least in part by focal length f₁ that has a positive value,
the second lens is characterized at least in part by a focal length f₂ that has a positive value,
the third lens is a bi-convex lens having a positive lens power such that the third lens is characterized at least in part by focal length f₃ that has a positive value,
the fourth lens is a bi-concave lens having a negative lens power such that the fourth lens is characterized at least in part by a focal length f₄ that has a negative value,
the fifth lens is characterized at least in part by a focal length f₅ that has a positive value, and
the sixth lens is a meniscus lens having a negative lens power such that the sixth lens is characterized at least in part by a focal length f₆ that has a negative value.

16. The imaging lens arrangement of claim 15 wherein the lenses configured to cooperate with one another such that the imaging lens arrangement exhibits an effective focal length having a value f, wherein f₁ satisfies the relationship 2.2 f<f₂<9.1 f, f₂ satisfies the relationship 1.5 f<f₂<6.3 f, f₃ satisfies the relationship 1.8 f<f₃<7.2 f, f₄ satisfies the relationship 1.1 f<−f₄<3.9 f, f₅ satisfies the relationship 1.2 f<f₅<4.8 f, and f₆ satisfies the relationship 0.9 f<−f₆<3.8 f.

17. The imaging lens arrangement of claim 16 wherein:
the first lens defines a first lens surface that is a flat surface, and a second, opposing lens surface that is a convex surface facing away from the display,
the second lens defines a third lens surface facing towards the first lens, and a fourth lens surface that is a convex surface facing away from the first lens,
the third lens defines a fifth lens surface that is a convex surface facing towards the second lens, and a sixth lens surface that is a convex surface and facing away from the second lens,
the fourth lens defines a seventh lens surface that is a concave surface facing towards the third lens, and an eighth lens surface that is a concave surface and facing away from the third lens,
the fifth lens defines a ninth lens surface facing towards the fourth lens, and a tenth lens surface that is a convex surface facing away from the fourth lens,
the sixth lens defines an eleventh lens surface that is a concave surface facing towards the fifth lens, and a twelfth lens surface that is a convex surface facing away from the fifth lens.

18. An imaging lens arrangement, for use in an image projector system having a display that emits an object image, the imaging lens arrangement comprising:
a first plano-convex lens having a positive lens power such that the first lens is characterized at least in part by focal length f₁ that has a positive value,
a second lens characterized at least in part by a focal length f₂ that has a positive value,
a third bi-convex lens having a positive lens power such that the third lens is characterized at least in part by a focal length f₃ that has a positive value,
a fourth bi-concave lens having a negative lens power such that the fourth lens is characterized at least in part by a focal length f₄ that has a negative value,
a fifth lens characterized at least in part by a focal length f₅ that has a positive value, and
a sixth meniscus lens having a negative lens power such that the sixth lens is characterized at least in part by a focal length f₆ that has a negative value,
wherein the lenses are configured to cooperate with one another such that the imaging lens arrangement exhibits an effective focal length having a value f and f₁ satisfies the relationship 2.2 f<f₁<9.1 f, f₂ satisfies the relationship 1.5 f<f₂<6.3 f, f₃ satisfies the relationship 1.8 f<f₃<7.2 f, f₄ satisfies the relationship 1.1 f<−f₄<3.9 f, f₅ satisfies the relationship 1.2 f<f₅<4.8 f, and f₆ satisfies the relationship 0.9 f<−f₆<3.8 f.

19. The imaging lens arrangement of claim 18 wherein:
the first lens defines a first lens surface that is an at least approximately planar surface facing towards the display, and a second, opposing lens surface that is a convex surface facing away from the display,
the second lens defines a third lens surface facing towards the first lens, and a fourth lens surface that is a convex surface facing away from the first lens,
the third lens defines a fifth lens surface that is a convex surface facing towards the second lens, and a sixth lens surface that is a convex surface and facing away from the second lens,
the fourth lens defines a seventh lens surface that is a concave surface facing towards the third lens, and an eighth lens surface that is a concave surface facing away from the third lens,
the fifth lens defines a ninth lens surface facing towards the fourth lens, and a tenth lens surface that is a convex surface facing away from the fourth lens,
the sixth lens defines an eleventh lens surface that is a concave surface facing towards the fifth lens, and a twelfth lens surface that is a concave surface facing away from the fifth lens.

20. The imaging lens arrangement of claim 19 wherein the first, second and sixth lenses are all composed of clear optical plastic, and the third, fourth and fifth lenses are composed of clear optical glass.

21. The imaging lens arrangement of claim 20 wherein an index of refraction of the first lens has a value from 1.48 to 1.84; the index of refraction of the second lens has a value from 1.48 to 1.60; the index of refraction of the third lens has a value from 1.60 to 1.82, the index of refraction of the fourth lens has a value from 1.62 to 1.85, the index of refraction of the fifth lens has a value from 1.50 to 1.85, and the index of refraction of the sixth lens has a value from 1.48 to 1.65.

22. The imaging lens arrangement of claim 21 wherein the index of refraction of the first lens is at least approximately 1.49; the index of refraction of the second lens is at least approximately 1.49; the index of refraction of the third lens is at least approximately 1.71, the index of refraction of the fourth lens is at least approximately 1.85, the index of refraction of the fifth lens is at least approximately 1.85, and the index of refraction of the sixth lens is at least approximately 1.49.

23. The imaging lens arrangement of claim 21 wherein an Abbe value of the first lens has a value from 23 to 84; the Abbe value of the second lens has a value from 40 to 64; the Abbe value of the third lens has a value from 41 to 64, the Abbe value of the fourth lens has a value from 21 to 35, the Abbe value of the fifth lens has a value from 21 to 39, and the Abbe value of the sixth lens having a value from 42 to 66.

24. The imaging lens arrangement of claim 23 wherein the Abbe value of the first lens is at least approximately 55.3; the Abbe value of the second lens is at least approximately 55.3; the Abbe value of the third lens is at least approximately 53.8, the Abbe value of the fourth lens is at least approximately 23.8, the Abbe value of the fifth lens is at least approximately 23.8, and the Abbe value of the sixth lens is at least approximately 55.3.

25. The imaging lens arrangement of claim 19 further comprising each of the curved surfaces is specified by a radius of curvature, wherein
a radius of curvature of the second surface, at least to an approximation, is 9.578 mm;
a radius of curvature of the fourth surface, at least to an approximation, is 6.478 mm;
a radius of curvature of the fifth surface, at least to an approximation, is 7.995 mm;
a radius of curvature of the sixth surface, at least to an approximation, is 4.708 mm;
a radius of curvature of the seventh surface is at least approximately 4.708 mm;
a radius of curvature of the eighth surface is at least approximately 8.605 mm;
a radius of curvature of the tenth surface, at least to an approximation, is 7.404 mm;
a radius of curvature of the eleventh surface, at least to an approximation, is 2.663 mm;
a radius of curvature of the twelfth surface, at least to an approximation, is 11.461 mm,
and each of the lenses can be characterized in part by a lens thickness, as a measure of distance, along the optical axis, of the opposing surfaces at a central location of each lens, wherein
a first lens thickness, of the first lens, is at least approximately 1.1 mm;
a second lens thickness, of the second lens, is at least approximately 1.7 mm;
a third lens thickness, of the third lens, is at least approximately 2.8 mm;
a fourth lens thickness, of the fourth lens, is at least approximately 0.6 mm;
a fifth lens thickness, of the fifth lens, is at least approximately 1.7 mm;
a sixth lens thickness, of the sixth lens, is at least approximately 1.0 mm,
and the third and fourth lenses are cemented together as a cemented doublet.

26. The imaging lens arrangement of claim 25 wherein the third lens surface is either an at least approximately planar surface; a convex surface having a radius of curvature from 31 mm to 4200 mm, or a concave surface having a radius of curvature from 70 mm to 5100 mm.

27. The imaging lens arrangement of claim 25 wherein the ninth lens surface is either an at least approximately planar surface; a convex surface having a radius of curvature from 28 mm to 4500 mm, or a concave surface having a radius of curvature from 65 mm to 4800 mm.

28. The imaging lens arrangement of claim 25 wherein a set of lens surfaces including the second, third, fourth, eleventh and twelfth lens surfaces are even aspherical lens surfaces, each one of which exhibits a sag z that varies with radius r from the optical axis, based on the expression
$$Z sag = \frac{{cr}^{2}}{1 + \sqrt{1 - ( k + 1 ) {c}^{2} {r}^{2}}} + {A}_{4} {r}^{4} + {A}_{6} {r}^{6} + {A}_{8} {r}^{8} + {A}_{10} {r}^{10}$$
wherein for each lens surface, c=R⁻¹, R is the radius of curvature for that lens surface, and k is a conic constant for that lens surface, A₄, A₆, A₈, and A₁₀ are aspheric coefficients for that lens surface, and each surface is configured according to

| Surface # | K | A₄ | A₆ | A₈ | A₁₀ |
|---|---|---|---|---|---|
| S2 | 0.549 | 1.1875E−3 | −1.1931E−4 | 4.1099E−6 | 1.4891E−7 |
| S4 | 0.966 | 1.0395E−4 | 5.7902E−6 | 2.1569E−6 | −1.7890E−7 |
| S11 | −0.815 | 3.4682E−3 | −2.3936E−4 | 9.8534E−6 | −1.7833E−7 |
| S12 | −51.346 | 1.4439E−4 | −1.2933E−5 | 3.5803E−7 | −3.7376E−9 |

29. The imaging lens arrangement of claim 25 wherein the lenses are arranged such that
a distance, along the optical axis, between the second lens surface and the beamsplitter, along the optical axis, is at least approximately 0.6 mm;
a distance, along the optical axis, between the beamsplitter and the third lens surface and, along the optical axis, is at least approximately 1.66 mm;
a distance, along the optical axis, between the fourth lens surface and the fifth lens surface, along the optical axis, is at least approximately 0.2 mm;
a distance, along the optical axis, between the eighth lens surface and the ninth lens surface, along the optical axis, is at least approximately 3.02 mm;
distance, along the optical axis, between the tenth lens surface and the eleventh lens surface, along the optical axis, is at least approximately 9.69 mm.

30. The imaging lens arrangement of claim 29 wherein the beamsplitter is a beamsplitter cube having a length that is at least 1.1 times the width of the display, and the distance between the second lens surface and third lens surface is at least as long as this length, and the beamsplitter cube includes an input surface, facing the first lens, and an opposing output surface, facing the second lens, and the cube is composed of an optical material that is a selected one of optical glass and optical plastic, the optical material having an index of refraction in a range from 1.48 to 1.88, and the cube has a cube thickness, between the input and output surfaces, of approximately 7 mm, and the cube is arranged such that a distance, along the optical axis, between the third lens surface and the output surface of the beamsplitter cube is in a range from 0.4 mm to 6 mm.

31. The imaging lens arrangement of claim 18 wherein:
the first lens defines a first lens surface that is a convex surface facing toward the display, and a second, opposing lens surface that is an at least approximately planar surface facing away from the display,
the second lens defines a third lens surface facing towards the first lens, and a fourth lens surface that is a convex surface facing away from the first lens,
the third lens defines a fifth lens surface that is a convex surface facing towards the second lens, and a sixth lens surface that is a convex surface and facing away from the second lens,
the fourth lens defines a seventh lens surface that is a concave surface facing towards the third lens, and an eighth lens surface that is a concave surface facing away from the third lens,
the fifth lens defines a ninth lens surface facing towards the fourth lens, and a tenth lens surface that is a convex surface facing away from the fourth lens,
the sixth lens defines a eleventh lens surface that is a concave surface facing towards the fifth lens, and a twelfth lens surface that is a concave surface facing away from the fifth lens.

32. The imaging lens arrangement of claim 31 wherein the third lens surface is an approximately planar surface.

33. The imaging lens arrangement of claim 32 wherein the first lens and the second lenses are integrally formed with beamsplitter.
